(19) United States
(12) Patent Application Publication
(10) Pub. No.: US 2024/0253987 A1
(43) Pub. Date: Aug. 1, 2024

(54) METHOD OF CAPTURING CARBON DIOXIDE FROM A STEAM METHANE REFORMER SYSTEM

(71) Applicant: FuelCell Energy, Inc., Danbury, CT (US)

(72) Inventors: Fred C. JAHNKE, Rye, NY (US); Stephen JOLLY, Middlebury, CT (US); Hossein GHEZEL-AYAGH, New Milford, CT (US)

(21) Appl. No.: 18/626,547

(22) Filed: Apr. 4, 2024

Related U.S. Application Data
(62) Division of application No. 17/194,597, filed on Mar. 8, 2021, now Pat. No. 11,975,969.
(60) Provisional application No. 62/987,985, filed on Mar. 11, 2020.

(51) Int. Cl. C01B 3/56; F25J 1/00; H01M 8/04007; H01M 8/0612; H01M 8/0656; H01M 8/14; H01M 16/00

(52) U.S. Cl. CPC C01B 3/56; F25J 1/0027; H01M 8/04007; H01M 8/0618; H01M 8/0656; H01M 8/14; H01M 16/003; C01B 2203/0233; C01B 2203/0425; C01B 2203/0475; C01B 2203/066; C01B 2203/0872; C01B 2203/148; C01B 2203/86; F25J 2205/50; F25J 2215/80; H01M 2008/147; Y02C 20/40

(57) ABSTRACT

A method of capturing carbon dioxide from a steam methane reformer system includes mixing tail gas from the steam methane reformer system with anode exhaust gas from an anode of a molten carbonate fuel cell to form a gas mixture, compressing the gas mixture, cooling the gas mixture, and separating the gas mixture into liquid carbon dioxide and a residual gas mixture.

### CROSS-REFERENCE TO RELATED PATENT APPLICATIONS

This application is a divisional of U.S. patent application Ser. No. 17/194,597, filed Mar. 8, 2021, which claims the benefit of and priority to U.S. Provisional Application No. 62/987,985, filed Mar. 11, 2020, both of which are incorporated by reference herein in their entireties.

### BACKGROUND

The present disclosure relates to a Steam Methane Reformer (SMR). In particular, the present disclosure relates to a SMR with enhanced carbon dioxide (CO₂) capture.

Steam methane reformers (SMRs) are generally used to produce a syngas from a gas feedstock such as natural gas or refinery gas. The produced syngas can be further processed within the plant to yield various end products, including purified hydrogen, methanol, carbon monoxide, and ammonia. However, the flue gas produced during the reforming process contains contaminants, such as carbon dioxide, which are known to adversely affect the environment by contributing to overall climate change. SMRs are known to be one of the largest CO₂ emitters in refineries. As such, in recent years, many government regulatory bodies have required the reduction in emissions of carbon dioxide, into the atmosphere.

Given the recognition of the harmful effect of carbon dioxide release and recent restrictions on its emission, efforts have been made to efficiently remove carbon dioxide in a purified form from a flue gas produced by a steam reformer plant. By removing carbon dioxide from the flue gas, the carbon dioxide alternatively may be used for other, safer purposes, such as underground storage or oil production needs.

Current methods for CO₂ capture from SMRs, such as, for example, using an amine absorption stripper system to remove CO₂ from flue gas (post-combustion capture) or using physical or amine-based chemical solvents in a stripper system to remove CO₂ from the SMR tail gas (pre-combustion capture), are highly inefficient and costly. The stripping systems are generally too energy-intensive, requiring significant quantities of steam to regenerate the solvents. The state-of-the-art post-combustion method employing molten carbonate fuel cell (MCFC) technology generates power while capturing CO₂ from a host plant. The additional power generated beyond the requirements of the system itself provides a source of revenue that offsets system capital and operating costs. In the conventional post-combustion system, flue gas from the SMR containing high levels of CO₂ is directed into the MCFC. Due to the high levels of CO₂, this method requires a relatively large quantity of MCFC modules, which can be costly and may produce more power than is desirable. As such, conventional MCFC-based CO₂ capture systems can be very expensive and may produce excess energy that cannot easily be unloaded.

### SUMMARY

Embodiments described herein provide a SMR-CO₂ capture system that captures CO₂ from a tail gas of a pressure swing adsorption (PSA) system of a SMR system, which can, advantageously, help to capture CO₂ in a more efficient and cost-effective manner, as compared to some conventional CO₂ capture systems.

In some embodiments, a system for capturing CO₂ from a SMR system comprises a MCFC, a compressor, a chiller, and a CO₂ separator. Exhaust gas from the anode of the MCFC may be mixed with tail gas from a PSA of the SMR system and compressed by the compressor. The mixed, compressed gas may be cooled by the chiller and fed into the CO₂ separator. The CO₂ separator separates liquefied CO₂ from the residual, uncondensed gas.

In various embodiments, the residual gas may be recycled into various parts of the SMR system or the system for capturing CO₂. For example, in some embodiments, a portion of the gas may be recycled to an anode gas oxidizer and then to a cathode of the MCFC, and another portion recycled into an anode of the MCFC. In some embodiments, a third portion of the residual gas may be recycled to the PSA of the SMR system to produce more hydrogen, or to a reformer in the SMR system to be burned as fuel. This third portion of residual gas may instead be recycled for use in a PSA outside the SMR system. In some embodiments, a third portion of the residual gas may be recycled to the PSA of the SMR system to produce more hydrogen, and a fourth portion of the residual gas may be recycled to a reformer in the SMR system to be burned as fuel.

In some embodiments, flue gas from a reformer of the SMR system may be vented to the atmosphere. Because the tail gas from the PSA of the SMR system is not burned to fuel the reformer of the SMR system, the flue gas is relatively low in CO₂. In other embodiments, the flue gas may be directed to an anode gas oxidizer in the system for capturing CO₂ and then to a cathode of the MCFC.

In some embodiments, the MCFC may be sized to power only the system for capturing CO₂, only the SMR system, or both. Because the tail gas from the PSA of the SMR system is not burned to fuel the reformer of the SMR system, the MCFC receives a reduced amount of CO₂, allowing the MCFC to be sized smaller and reducing excess power generation.

In some embodiments, a system for capturing CO₂ from a SMR system comprises a compressor, a chiller, and a CO₂ separator, but excludes an MCFC as power for the system may be derived from an external power source such as an existing power plant, utility grid, and/or renewable power such as solar or wind power. Tail gas from a PSA of the SMR system is compressed by the compressor and cooled by the chiller. The CO₂ separator separates liquefied CO₂ from the residual, uncondensed gas. The uncondensed gas may then be recycled to the PSA of the SMR system and/or to the reformer of the SMR system to be burned as fuel.

In some embodiments, a method comprises mixing anode exhaust gas from the anode of a MCFC with tail gas from the PSA of a SMR system, compressing the mixed gas with a compressor, cooling the mixed gas with a chiller, separating liquefied CO₂ from residual, uncompressed gas in a separator, and collecting the liquefied CO₂. In some embodiments, the residual gas may be recycled in varying amounts to an anode gas oxidizer coupled to a cathode of the MCFC, the anode of the MCFC, the PSA of the SMR system, and/or to a reformer of the SMR system to be burned as fuel.

The foregoing is a summary of the disclosure and thus by necessity contains simplifications, generalizations, and omissions of detail. Consequently, those skilled in the art will appreciate that the summary is illustrative only and is not intended to be in any way limiting. Other aspects, features, and advantages of the devices and/or processes described herein, as defined by the claims, will become apparent in the detailed description set forth herein and taken in conjunction with the accompanying drawings.

### BRIEF DESCRIPTION OF THE FIGURES

The disclosure will become more fully understood from the following detailed description, taken in conjunction with the accompanying figures, wherein like reference numerals refer to like elements, in which:

FIG. 1 shows a schematic view of a conventional SMR-CO₂ capture system.

FIG. 2 shows a schematic view of a SMR-CO₂ capture system, in accordance with a representative embodiment of the present disclosure.

FIG. 3 shows a schematic view of a SMR-CO₂ capture system, in accordance with another representative embodiment.

FIG. 4 shows a schematic view of a SMR-CO₂ capture system, in accordance with yet another representative embodiment.

FIG. 5 shows a schematic view of a SMR-CO₂ capture system, in accordance with yet another representative embodiment.

FIG. 6 shows a method of capturing CO₂ from a SMR, in accordance with a representative embodiment.

### DETAILED DESCRIPTION

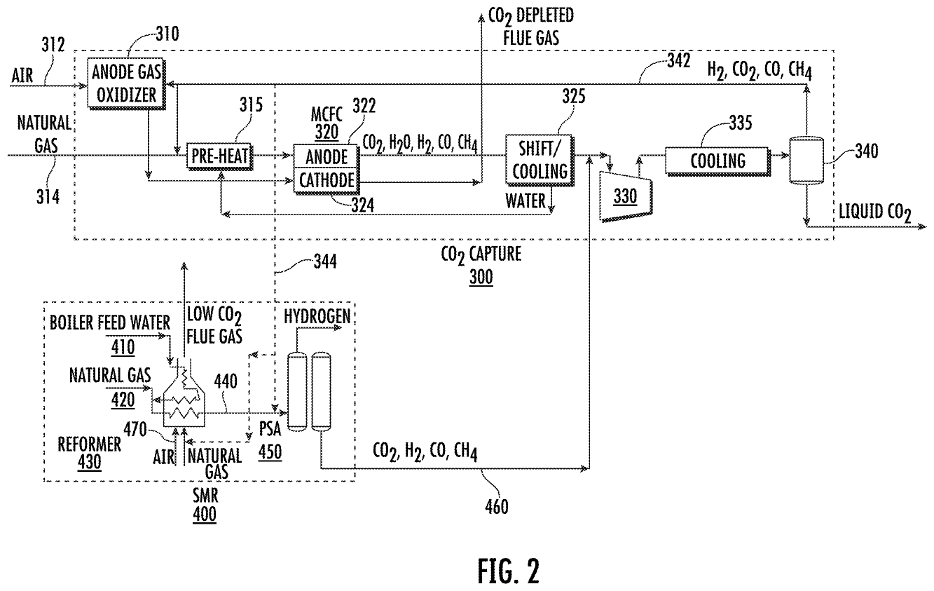

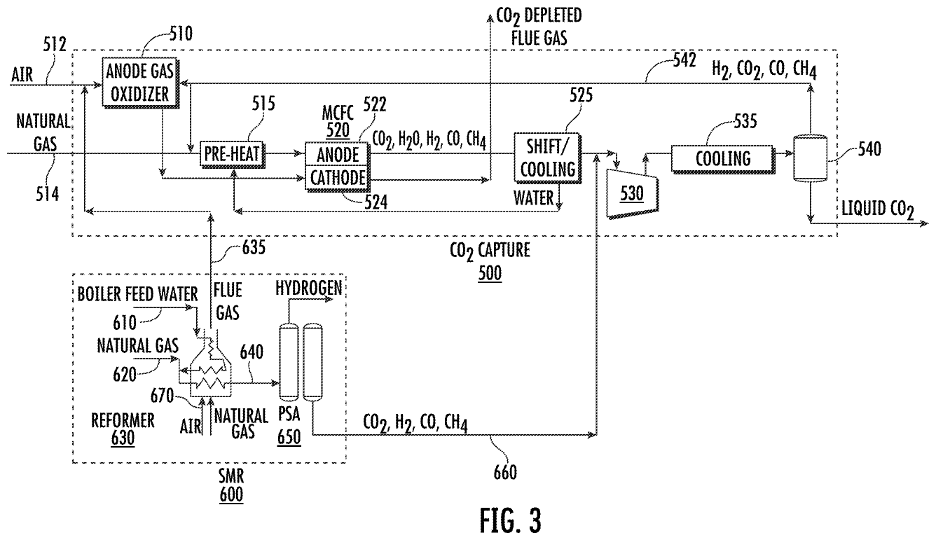

Referring generally to the figures, disclosed herein are various embodiments of an enhanced SMR-CO₂ capture system capable of capturing CO₂ in a more efficient and cost-effective manner, as compared to some conventional CO₂ capture systems. The various embodiments disclosed herein may be capable of increasing the amount of CO₂ captured, improving efficiency of capturing CO₂, increasing the amount of hydrogen produced, and/or reducing costs associated with capturing CO₂. In the various embodiments disclosed herein, like reference numerals refer to like elements between Figures, but are increased by 200 from figure to figure (e.g., PSA 450 in FIG. 2 is the same as PSA 650 in FIG. 3, etc.).

Generally speaking, in a typical SMR unit of a SMR-CO₂ capture system, natural gas is reacted with water to form hydrogen and CO₂. Some methane is unconverted and some carbon monoxide is also generated in the process. These impurities, along with any water that is not separated out by condensation, are normally removed from the hydrogen using a PSA system, which can desorb these impurities at atmospheric pressure to generate a PSA tail gas that is generally high in CO₂ and also contains CO, methane, and hydrogen. Typically, the PSA tail gas is recycled as fuel in the SMR unit, where the gases are combusted with air to provide the heat needed for the endothermic reforming reaction. This reaction produces a flue gas having relatively high CO₂ content that can be directed to an MCFC for subsequent CO₂ capture. In this type of system configuration, the size of the MCFC is dictated, in part, by the amount (or percentage) of CO₂ to be transferred to the anode of the MCFC from the flue gas received from the SMR unit (e.g., 70%-90% of the CO₂).

However, the composition of the PSA tail gas is very similar to the shifted anode exhaust gas of the MCFC in the CO₂ capture system. Thus, Applicant advantageously determined that the PSA tail gas could be mixed directly with the anode exhaust gas of the MCFC before being compressed and cooled to separate the CO₂ from the gas, instead of recycling the PSA tail gas in the SMR unit. In this manner, the size of the MCFC is not dictated by the PSA tail gas from the SMR unit, since the CO₂ that is normally contained in the flue gas from the PSA tail gas is mixed with the anode exhaust gas downstream of the MCFC for subsequent CO₂ capture instead. Accordingly, the overall cost of the system can be reduced by selecting a smaller sized MCFC that can, for example, produce just enough power for the chiller and other electrical loads of the CO₂ capture system, the SMR system itself, or both, as discussed in greater detail below.

In some implementations, the system can also be configured to direct the flue gas from the SMR unit to the MCFC for additional CO₂ capture. In some implementations, the unused fuel from the anode of the MCFC containing hydrogen and carbon monoxide can be directed from a CO₂ capture tail gas to the PSA to increase the hydrogen production of the system. In some implementations, power is purchased from an external source instead of using an MCFC to power the CO₂ capture system.

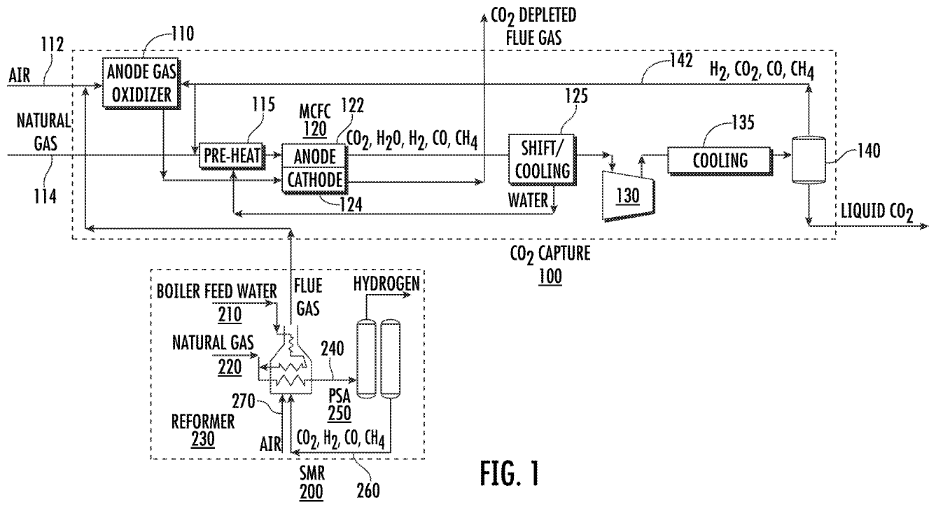

FIG. 1 shows a typical SMR-CO₂ capture system. As shown in FIG. 1, steam supplied by a steam supply line 210 and natural gas supplied by a natural gas supply line 220 are mixed and fed to a reformer 230 of a reformer system 200 for converting the methane to hydrogen, CO₂, and CO. The reformer effluent may be transported to a shifting assembly of the reformer system 200, where the effluent may be cooled and most of the CO can be shifted to hydrogen according to the reaction:

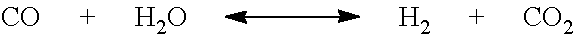

The shifted gas is then sent via shift gas line 240 to a PSA system 250 where the hydrogen is separated from the residual methane and CO in the gas along with the CO₂ produced from the reforming and shift reactions. The residual gases are recycled as fuel to the reformer 230 via a recycling line 260, where the gases are combusted with air supplied by an air supply line 270 to provide the heat needed for the endothermic reforming reaction. All of the CO₂ generated in the production of the hydrogen is vented in the reformer flue gas as a mixture of N₂, CO₂, and H₂O with some NOₓ.

Still referring to FIG. 1, the reformer flue gas containing the CO₂ is sent to an AGO (anode gas oxidizer) 110 of a CO₂ capture system 100 where the flue gas is optionally combined with air, if required to increase the flue gas oxygen content to the level required for MCFC operation, from an air supply line 112. The flue gas and air are heated and fed into a cathode 124 of an MCFC 120. Natural gas is provided to a pre-heater 115 before being fed to an anode 122 of the MCFC 120 via a natural gas supply line 114. Due to the unique properties of the MCFC, CO₃^{═} is transferred from the cathode 124 to the anode 122 of the MCFC 120 during normal power production of the MCFC. This transfer removes CO₂ and O₂ from the flue gas containing cathode feed and generates a cathode exhaust, which is relatively low in CO₂, thereby reducing CO₂ emissions. The CO₃^{═} transferred to the anode 122 reacts with hydrogen in the anode 122 to form H₂O and CO₂ while generating power. In the carbon capture process, the outlet stream from the anode 122 is cooled by, for example, an evaporator 125, and enters a shift reactor such that CO in the outlet stream is converted to hydrogen and CO₂ using the following shift reaction:

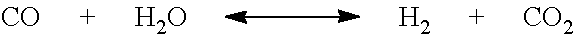

The outlet stream is then compressed by a compressor 130 and then cooled by, for example, a chiller 135. The compressed and cooled outlet stream is then transferred to a CO₂ separator 140. In the compressed and cooled outlet stream, about 60% to about 90% of the CO₂ is condensed as a liquid and separated from a residual CO₂ capture tail gas containing hydrogen, any unconverted CO, the remaining uncondensed CO₂, and methane. The residual CO₂ capture tail gas is partially recycled to the anode 122 via a recycle line 142 to be used as fuel in the MCFC 120. The remainder of the residual CO₂ capture tail gas is sent to the AGO 110 to help prevent buildup of inert gases, such as nitrogen, and to heat up the gas in the AGO 110 by combusting the remaining hydrogen gas from the residual CO₂ capture tail gas. This recycling has the advantage of increasing the amount of CO₂ recovered from the anode exhaust.

In the system of FIG. 1, the MCFC 120 is sized, in part, based on the amount of CO₂ in the flue gas to transfer to the anode 122 (e.g., about 70% to about 90% of the CO₂ in the flue gas). Thus, the system configuration of FIG. 1 can be costly to implement and may generate more power than desirable.

Referring now to FIG. 2, a SMR-CO₂ capture system including a CO₂ capture system 300 and a SMR system 400 is shown according to an exemplary embodiment of the present disclosure. In contrast to the system of FIG. 1, the flue gas from the SMR system 400 is not directed to the MCFC for CO₂ capture but is instead vented since it has generally low CO₂ content. Instead, the SMR system 400 is configured such that a PSA tail gas from a PSA 450 in the SMR system 400 is mixed directly with an anode exhaust gas from an anode 322 of an MCFC 320, where the mixture can be compressed and cooled, such that liquefied CO₂ can be separated from the mixture to be captured. In this way, the size of the MCFC 320 is independent of the flue gas from the SMR reformer 430, such that the MCFC 320 may be sized to provide only the power needed by the CO₂ capture system 300, the SMR system 400, or both, thereby reducing the overall cost of the system while still providing adequate CO₂ capture.

Still referring to FIG. 2, steam supplied by a steam supply line 410 and natural gas supplied by a natural gas supply line 420 are mixed and fed to a SMR reformer 430 of a SMR system 400 for converting the methane to hydrogen, CO₂, and CO. The reformer effluent may be transported to a shifting assembly of the SMR system 400, where the effluent may be cooled and most of the CO can be shifted to hydrogen. The shifted gas is then sent via shift gas line 440 to a PSA 450 where the hydrogen is separated from the residual methane and CO in the gas along with the CO₂ produced from the reforming and shift reactions. Instead of recycling the residual gases in the PSA tail gas as fuel in the SMR reformer 430, as in the system of FIG. 1, the PSA tail gas is directed to the CO₂ capture system 300 by a PSA tail gas supply line 460 to be mixed directly with the anode exhaust gas of the anode 322 of the MCFC 320 for subsequent CO₂ capture. In this way, the size of the MCFC 320 is not dictated by the amount of CO₂ in the PSA tail gas to be transferred to the anode 322. The MCFC 320 can therefore be sized to any specifications, for example, to produce sufficient power for the CO₂ capture system 300, the SMR system 400, or both.

Still referring to FIG. 2, the mixture of anode exhaust gas and the PSA tail gas is then compressed by a compressor 330 and then cooled by, for example, a chiller 335. The compressed and cooled outlet stream is then transferred to a CO₂ separator 340. In the compressed and cooled outlet stream, about 60% to about 90% of the CO₂ is condensed as a liquid and separated from a residual CO₂ capture tail gas containing hydrogen, any unconverted CO, the remaining uncondensed CO₂, and methane. A portion of the CO₂ capture tail gas stream is recycled to the anode 322 via a recycle line 342 to be used as fuel in the MCFC 320, with a small portion of the tail gas also being sent to the AGO 310 to help to prevent buildup of inert gases, such as nitrogen, and to heat up the gas in the AGO 310 by combusting the remaining hydrogen gas from the residual CO₂ capture tail gas.

In the system configuration of FIG. 2, the PSA tail gas is no longer being directed back to the SMR Reformer 430 for subsequent burning. As such, natural gas may be used instead to provide fuel to SMR Reformer 430, and the resulting flue gas containing a relatively low amount of CO₂ can be vented as a mixture of N₂, CO₂, and H₂O with some NOₓ as allowed by regulation. In this configuration, about 50% to about 60% of the CO₂ normally emitted from the SMR is captured.

According to another representative embodiment shown in FIG. 2, a portion of the residual CO₂ capture tail gas may also be directed back to SMR Reformer 430 by a CO₂ capture tail gas supply line 344 (represented by dashed lines/arrows). The portion of the residual CO₂ capture tail gas can be used as fuel in SMR Reformer 430, so as to reduce the amount of natural gas required. The portion of the residual CO₂ capture tail gas may also be recycled to the PSA 450, as shown in FIG. 2, to increase the H₂ production of the PSA without increasing the size of SMR Reformer 430. According to another representative embodiment, the MCFC 320 may be sized to use only the residual CO₂ capture tail gas as fuel, thereby eliminating the need for natural gas at the MCFC 320, except for startup and upset operations.

Referring now to FIG. 3, a SMR-CO₂ capture system including a CO₂ capture system 500 and a SMR system 600 is shown according to another exemplary embodiment of the present disclosure. In contrast to the system of FIG. 2, the flue gas from the SMR system 600 is directed to the MCFC along a flue gas supply line 635 for CO₂ capture, instead of being vented. In addition, tail gas from a PSA 650 of the SMR system 600 is directed along a PSA tail gas supply line 660 to be mixed directly with an anode exhaust from the anode 522 of the MCFC 520 for capturing CO₂. In this way, the MCFC 520 can be sized to be smaller than in a typical SMR-CO₂ capture system (such as the system of FIG. 1), since the tail gas containing about 50-60% of the CO₂ normally present in the flue gas to be captured by the MCFC 520 is directed to the anode exhaust of the MCFC instead. Thus, this exemplary system can provide relatively higher CO₂ capture, as compared to the system of FIG. 2, while still reducing overall cost, as compared to the conventional system of FIG. 1.

According to another representative embodiment, the size of the MCFC 520 is configurable to offset the power consumed by the CO₂ capture system 500 and the SMR system 600. In this configuration, a relatively large percentage of the normally emitted CO₂ (e.g., about 60% to about 70%) would still be captured by the system, but the capital cost would be significantly reduced and the need to export power to a third party would be eliminated or reduced.

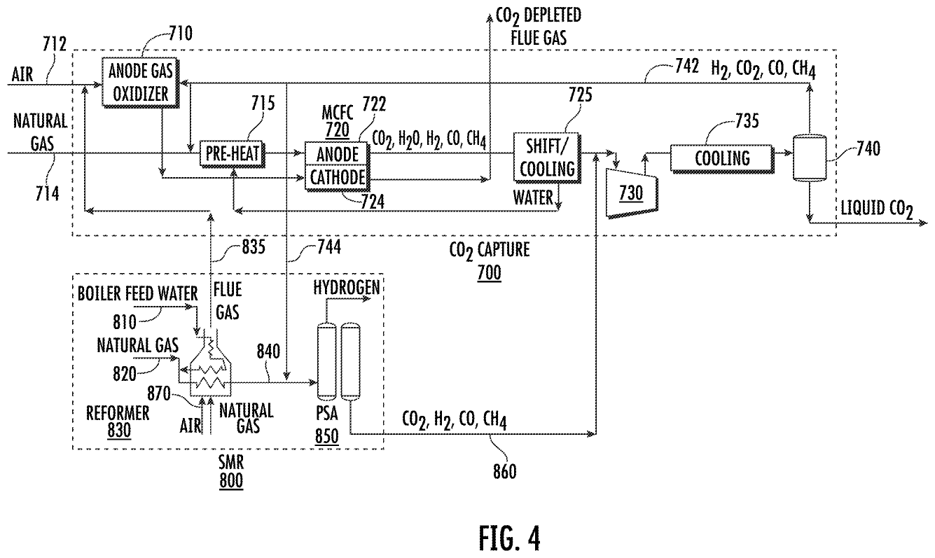

Referring now to FIG. 4, a SMR-CO₂ capture system including a CO₂ capture system 700 and a SMR system 800 is shown according to another exemplary embodiment of the present disclosure. As shown in FIG. 4, flue gas from the SMR system 800 is directed along a flue gas supply line 835 to the cathode 724 of an MCFC 720, and tail gas from a PSA 850 of the SMR system 800 is directed along a PSA tail gas supply line 860 to be mixed directly with an anode exhaust from the anode 722 of the MCFC 720 for capturing CO₂. The unused fuel from the anode 722 containing hydrogen and carbon monoxide (e.g., about 30%) with small amounts of methane, can be directed from the CO₂ capture tail gas to the PSA 850 along a CO₂ capture tail gas supply line 744 to increase the hydrogen production of the system. In some embodiments, the CO₂ capture tail gas could be sent to a separate PSA from the PSA 850 if, for example, the PSA 850 did not have the required capacity for the additional feed. In this manner, this exemplary system can provide for relatively high CO₂ capture and increased hydrogen production, while reducing overall cost.

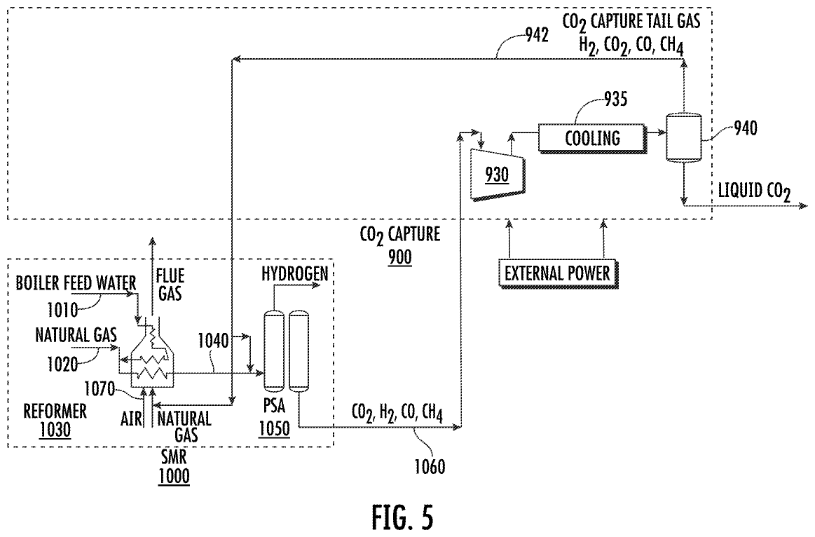

Referring now to FIG. 5, a SMR-CO₂ capture system including a CO₂ capture system 900 and a SMR system 1000 is shown according to another exemplary embodiment of the present disclosure. As shown in FIG. 5, power is received from an external source instead of using an MCFC to power the CO₂ capture system 900. The external power source could be an existing power plant, utility grid, and/or renewable power such as solar or wind power, according to various exemplary embodiments. The tail gas from a PSA 1050 of the SMR system 1000 is compressed by the compressor 930 and cooled by the chiller 935, such that the liquefied CO₂ can be separated from the gas for capturing CO₂. The CO₂ capture tail gas may be directed along a PSA tail gas supply line 942 to the PSA 1050 and/or to the reformer 1030 of the SMR system 1000, so as to increase the hydrogen production of the system and help to prevent build-up of inert gases in the SMR system 1000. In this manner, this exemplary system can provide a lower-cost option for capturing CO₂, as compared to other CO₂ capture systems. It should be appreciated, however, that the amount of potential CO₂ that is released by the external power source should be taken into account when estimating the amount of CO₂ reduction with this configuration.

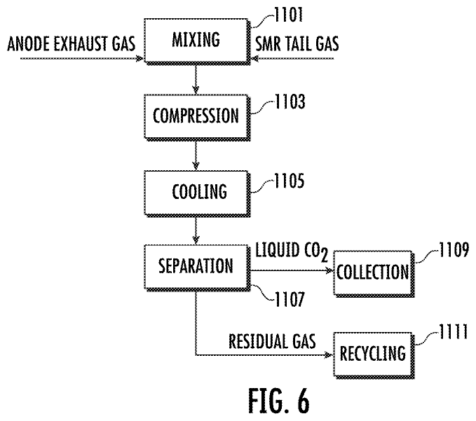

Referring to FIG. 6, a method of implementing the systems described above is shown according to an exemplary embodiment. The exemplary method includes a mixing step 1101 in which tail gas from the PSA of the SMR system is mixed with anode exhaust gas from the anode of the MCFC; a compression step 1103 in which the mixed gasses are compressed by a compressor; a cooling step 1105 in which the gases are cooled by, for example, a chiller such that most of the CO₂ is output as a liquid; a separation step 1107 in which the liquid CO₂ is separated from the residual gases by a CO₂ separator; a collection step 1109 in which the liquid CO₂ is collected to be sequestered or used for other purposes; and a recycling step 1111, in which the residual gases are recycled for use in one of more of an anode gas oxidizer, the anode of the MCFC, the SMR as a fuel source for the reformer, and the PSA to produce hydrogen gas. In certain embodiments, the mixing step 1101 is omitted and SMR tail gas is processed without mixing with anode exhaust gas, particularly when an external power source is used in place of a MCFC.

According to a representative embodiment, tail gas from a PSA in a SMR system is mixed directly with an anode exhaust gas from the anode of an MCFC, where the mixture can be compressed and its temperature lowered by a chiller, such that liquefied CO₂ can be separated from the mixture to be captured. The CO₂ from the combustor of the reformer of the SMR system, i.e. the flue gas from the SMR system, is not directed to the MCFC for CO₂ capture, as compared to some conventional SMR-CO₂ capture systems. In this way, the size of the MCFC is independent of the flue gas from the SMR reformer and instead is governed by the CO₂ capture from the PSA tail gas, thereby reducing the overall cost of the system while still providing CO₂ capture.

According to another representative embodiment, flue gas from a SMR system is sent to the cathode of an MCFC, and tail gas from a PSA of the SMR system is mixed directly with an anode exhaust from the anode of the MCFC for capturing CO₂. In this way, the MCFC can be sized to be smaller than in a typical SMR-CO₂ capture system, since the tail gas containing about 50-60% of the CO₂ normally present in the flue gas to be captured by the MCFC is directed to the anode exhaust of the MCFC instead. Thus, this exemplary system can provide relatively high CO₂ capture while reducing overall cost of the system.

According to another representative embodiment, flue gas from a SMR system is sent to the cathode of an MCFC, and tail gas from a PSA of the SMR system is mixed directly with an anode exhaust from the anode of the MCFC for capturing CO₂. A portion of the unused fuel from the anode of the MCFC, following removal of CO₂ and containing hydrogen and carbon monoxide (CO), can be directed from the CO₂ capture tail gas to the PSA to increase the hydrogen production of the system. In this manner, this exemplary system can provide for relatively high CO₂ capture and increased hydrogen production, while reducing overall cost of the system.

According to another representative embodiment, the tail gas from a PSA of the SMR system is compressed and its temperature lowered by a chiller using an external power source (and, in cases where an absorption chiller is used, an external heat source), such that the liquefied CO₂ can be separated from the gas for capturing CO₂. The unused fuel from the CO₂ capture tail gas containing hydrogen, CO, residual CO₂, and other non-condensable gases may be directed to the PSA so as to increase the hydrogen production of the system, and/or to the reformer of the SMR system, helping to prevent build-up of inert gases in the SMR system. In this manner, this exemplary system can provide a lower-cost option for capturing CO₂, as compared to some conventional SMR-CO₂ capture systems.

Disclosed herein are various embodiments of an enhanced SMR-CO₂ capture system capable of capturing CO₂ in a more efficient and cost-effective manner, as compared to some conventional CO₂ capture systems using MCFC. The various embodiments disclosed herein may be capable of increasing the amount of CO₂ captured, improving efficiency of capturing CO₂, increasing the amount of hydrogen produced, and/or reducing costs associated with capturing CO₂.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” etc.) are merely used to describe the orientation of various elements in the Figures. It should be noted that the orientation of various elements may differ according to other exemplary embodiments, and that such variations are intended to be encompassed by the present disclosure.

It is important to note that the construction and arrangement of the various exemplary embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Other substitutions, modifications, changes and omissions may also be made in the design, operating conditions and arrangement of the various exemplary embodiments without departing from the scope of the present invention. For example, the heat recovery heat exchangers may be further optimized.

What is claimed is:

1. A method of capturing carbon dioxide from a steam methane reformer system, the method comprising:
mixing tail gas from the steam methane reformer system with anode exhaust gas from an anode of a molten carbonate fuel cell to form a gas mixture;
compressing the gas mixture;
cooling the gas mixture; and
separating the gas mixture into liquid carbon dioxide and a residual gas mixture.

2. The method of claim 1, further comprising directing a first portion of the residual gas mixture to the anode of the molten carbonate fuel cell.

3. The method of claim 2, further comprising combusting a second portion of the residual gas mixture in an anode gas oxidizer to generate an anode gas oxidizer output stream.

4. The method of claim 3, further comprising directing the anode gas oxidizer output stream to a cathode of the molten carbonate fuel cell.

5. The method of claim 2, further comprising directing a third portion of the residual gas mixture to the steam methane reformer system to be burned as fuel.

6. The method of claim 5, further comprising directing a fourth portion of the residual gas mixture to a pressure swing adsorption system in the steam methane reformer system.

7. The method of claim 2, further comprising directing a third portion of the residual gas mixture to a pressure swing adsorption system in the steam methane reformer system.

8. The method of claim 7, wherein the tail gas is generated by the pressure swing adsorption system.

9. The method of claim 1, wherein the tail gas is generated by a pressure swing adsorption system in the steam methane reformer system.

10. The method of claim 1, further comprising:
supplying a flue gas from a steam methane reformer of the steam methane reformer system and a portion of the residual gas mixture to an anode gas oxidizer;
combusting the portion of the residual gas mixture with the flue gas to generate an anode gas oxidizer output stream; and
directing the anode gas oxidizer output stream to a cathode of the molten carbonate fuel cell.

11. The method of claim 1, further comprising:
reforming a natural gas stream in a steam methane reformer of the steam methane reformer system to generate a flue gas and a reformer output stream;
directing the reformer output stream to a pressure swing adsorption system of the steam methane reformer system;
separating the reformer output stream into a hydrogen stream and the tail gas using pressure swing adsorption; and
venting the flue gas.

12. A method of capturing carbon dioxide in a purified hydrogen production system, the method comprising:
reforming a natural gas stream with steam in a steam methane reformer to produce reformer effluent comprising hydrogen, carbon dioxide, methane, and carbon monoxide;
separating the hydrogen from the reformer effluent using pressure swing adsorption to product a purified hydrogen stream and a tail gas;
combining the tail gas with anode exhaust from an anode of a molten carbonate fuel cell;
liquefying and separating carbon dioxide from the combined tail gas and anode exhaust to produce a residual gas stream; and
supplying a first portion of the residual gas stream to the anode of the molten carbonate fuel cell.

13. The method of claim 12, further comprising shifting a portion of the carbon monoxide in the reformer effluent with steam to produce additional carbon dioxide and hydrogen before separating the hydrogen from the reformer effluent.

14. The method of claim 12, further comprising:
combusting a second portion of the residual gas stream in an anode gas oxidizer to generate an anode gas oxidizer output stream; and
supplying the anode gas oxidizer output stream to a cathode of the molten carbonate fuel cell.

15. The method of claim 14, further comprising:
burning natural gas to supply heat to the steam methane reformer and generate a flue gas; and
supplying the flue gas to the anode gas oxidizer.

16. The method of claim 12, further comprising mixing a second portion of the residual gas stream with the reformer effluent before separating the hydrogen from the reformer effluent.

17. The method of claim 12, further comprising shifting carbon monoxide in the anode exhaust to carbon dioxide before combining the tail gas with the anode exhaust.

18. The method of claim 12, further comprising:
separating water from the anode exhaust; and
supplying the water and the first portion of the residual gas stream to a preheater to humidify the first portion of the residual gas stream before supplying the first portion of the residual gas stream to the anode of the molten carbonate fuel cell.

19. The method of claim 12, wherein liquefying and separating the carbon dioxide from the combined tail gas and anode exhaust comprises compressing and cooling the combined tail gas and anode exhaust.

20. The method of claim 12, further comprising burning a second portion of the residual gas stream to supply heat to the steam methane reformer.
